(19) United States
(12) Patent Application Publication
(10) Pub. No.: US 2011/0083637 A1
(43) Pub. Date: Apr. 14, 2011

(54) Rotary double engine

(76) Inventor: David H. Blount, San Diego, CA (US)

(21) Appl. No.: 12/587,490

(22) Filed: Oct. 8, 2009

(51) Int. Cl. F02B 53/04; F02B 53/00

(52) U.S. Cl. 123/220; 123/243

(57) ABSTRACT

A rotary double engine comprising of two separate engines, one in the peripheral area of the housing cavity and one in the central area of the rotor. A number of expansion chambers and compression chambers are formed between the anterior wall, posterior wall, housing inner wall and movable vanes which extends from the inner peripheral surface of the housing through the slots in the eccentric located rotor to the centrally located cam and bears on the inner peripheral surface of the housing, inner surface of the anterior wall, inner surface of the posterior wall and outer surface of the cam. The expansion chambers expand and contract during the operation of the engine. The output shaft is connected to and passes centrally through the rotor and extends out through the anterior wall and posterior wall and bearings. Intake port in the housing front wall or posterior wall allows pressurized air or air/fuel mixture to pass into the expansion chambers of the peripheral engine and or central engine. The rotor and shaft are rotated by the compressed gas and/or combustion pressure on the vanes and rotor from the expanding pressurized air or combustion of the air/fuel mixture. Expanded pressurized air from the peripheral engine is passed through passage to the central engine to be further expanded or to be mixed with a fuel mixture to be ignited and the combustion gases used to rotate the rotor and shaft and to heated the pressured air as in the peripheral engine.

### BACKGROUND OF THE INVENTION

This invention relates to an apparatus for producing rotary motion force which does not have a conventional crankshaft and may be in the form of a double internal combustion engine, a double fluid driven motor such as a double air motor or a double steam driven engine or a compressed gas driven peripheral engine and an internal combustion engine in the central engine to utilized the heat from combustion to heat the compressed gas. This apparatus may also be used as a pump and a compressor. This apparatus has two engines wherein one is located in the peripheral area of the double engine and another located in the central area of the rotor of the double engine which is separated by a rotor which has slots for the movable vanes which separate the expansion and compression chambers of each engine.

Many rotary engines have been invented in the past such as James Watt's steam engine, Gilbert's engine, Cooley's engine, Selwood's engine, Wankel's engine, Walter's engine, Mercer engine, Porsche rotary engine, Franke's engine, Blount's engines and Di Pietro's engine but none of these engine has a engine with a double rotary engine. The apparatus of this invention is entirely different from the known types of rotary engines.

The novel apparatus of this invention is relatively simple in construction and operation whereby the double engine can be produced at relatively low cost. Fewer parts are required in the construction when compared with conventional rotary and reciprocal engines. The basic double engine of this invention consist of a stationary housing with cylindrical inner wall, front and back side walls, circular rotor rotationally mounted in the housing on an eccentric located shaft in the housing which protrude through the side walls and the rotor contains slots that movable vanes pass through which seal off the expansion chambers and compression chambers from each other and from the peripheral and central expansions and compression chamber of the peripheral and central engines. The rotor contains the central engine. The expansion and compression chambers vary in size by the eccentric rotation of the rotor around the stationary cam located in the center of the housing and the vanes slide through and rotate with the cylindrical rotor while bearing against the inner housing wall, outer wall of the cam and the side walls. The peripheral engine is formed between the inner housing wall and the outer wall of the rotor and the side walls. The central engine is formed in the center of the rotor between the inner peripheral side wall of the rotor, front wall of the rotor, cam's outer peripheral wall and the inner posterior side wall of the housing. The size of the center and peripheral engine may vary depending one the size rotor or the housing. The center engine maybe larger than the peripheral engine.

This novel double engine design improves the efficiency of the of the engine operation and is extremely desirable. When the peripheral engine is powered by a compressed gas and the central engine is powered by a combustible fuel and partially decompressed air from the peripheral engine the heat of the combustion is utilized to heat the expanding compressed gas thereby producing a great force from the expanding gas because an expanding gas becomes very cold which reduces it's expansion force. This design of the rotary double engine allows various method for it to be powered and it may be powered by compressed gas in both engines, by compressed gas in the peripheral engine and combustible fuel and air in the central engine, by combustible fuel in both engines and by compressed air in the central engine and combustible fuel in the peripheral engine. To use these various methods to power the engines it is only necessary to change the intake locations and the ignition location. When the peripheral engine is powered by a compressed gas the central engine can be powered by the partially decompressed gas from exhaust ports of the peripheral engine. When the peripheral engine is powered by a combustible fuel the central engine can be powered by the exhaust gases from the peripheral engine and the engines maybe cooled by fins or by a water cooling system.

### SUMMARY OF THE INVENTION

The object of the present invention is to produce an improved rotary engine which contains two engines which utilizes the same rotor and vanes to produce the engines. Another object is to provide a novel apparatus which is a rotary double engine which can be powered by compressed gas and/or combustible fuel. Another object is to utilized the heat of combustion to heat the expanding compressed gas which produces a greater force to rotate the shaft. Another object is to provide a novel apparatus which is a rotary double engine that can be powered by compressed gas and/or a combustible fuel and has the strokes of suction, compression, expansion and exhaustion in both engines and ignition in at least one engine. Still another object is to produce multiple arrangements of the rotary double engine of this invention. Another object is to produce an apparatus which may be utilized as a compressor and as an engine powered by the expansion of heated gases or liquids. It is an object of this invention to provide alternative form of a non-reciprocating type motor or engine which overcomes one or more of the shortcomings of prior art engines such as utilizing the heat of combustion.

The rotary double engine of this invention consist of:

1. Housing, a stationary hollow housing having a cylindrical inner peripheral wall which forms a circular cavity with room for a rotor to rotate, and has an anterior and posterior side wall. The housing or side walls has intake ports for admitting compressed gas, air/fuel mixtures, combustible fuel, or heated gases or liquids to the expansion chamber of the peripheral engine and central engine and ignition system when a combustible fuel is utilized. The housing or side walls has exhaust ports for discharging combustion gas and partially decompressed gas. The housing or side walls has one or more ports which open up into the expansion or compression chamber for admitting a combustible fuel and/or fuel/gas mixture and may have fuel injection ports in the housing or side walls which open up into a expansion or compression chamber. There are one or more spark plugs or glow plugs ports in the housing or wall when combustible fuel is use which opens up into an expansion chamber.

2. Rotor, eccentrically located in the housing, a rotatable cylindrical rotor with expansion and compression chamber in the center of one side of the rotor with slots passing thru the exterior peripheral wall to the rotor to the exterior wall of the cam and has an opening in the center of the anterior side wall for the shaft to pass through and be attached to the rotor and a chamber in the central area of the rotor for the central engine.

3. Shaft, consisting of a round shaft which passes through the center of the rotor, means to attach to the rotor, then passes eccentrically through the anterior and posterior walls and through a bearing on both wall and extends out from the walls.

4. Cam, which is stationary in the center of the posterior wall, cylindrical, hallow for oil storage and extends inward from the posterior wall to the inner anterior wall of rotor and guides the vanes when rotating.

5. Vanes, which are movable solid flat material of equal size and shape that is mounted in the slots in the rotor and bears on the inner peripheral surface of the housing, the inner surface of the posterior and anterior wall and exterior wall of the cam thereby sealing the expansion chambers from each other and sealing the compression chambers from each other. There may be as many vanes as desired to divide the expansion chambers ranging from 4 to 20 vanes and 6 vanes are probably the best number to use.

6. Seals, which are located on the walls of the rotor to seal the peripheral engine from the central engine and seal the compression chamber and compression chamber from each other.

7. Ignition system, consist of means for ignition of combustible fuel.

8. Fuel system, consist of means for supplying combustible fuel and air to combustion chambers.

9. Compressed gas system, consist of means for supplying compressed gas, means to regulate the pressure of the compressed gas and means to regulate timing for the compressed gas to enter the expansion chamber and for the length of time that compressed gas enters the expansion chamber.

10. Oil chamber, located in the center of the cam with distribution channels to surfaces that needs to be oiled.

11. Flywheel, located on the shaft outside the double engine.

This invention provides an engine comprising a rotatable rotor which is the rotatable shaft driver located in the housing cavity of the engine surrounded by expansion chamber in the peripheral area of the housing and in the center of the rotor which are divided by movable vanes which pass through slots in the rotor and bears on the peripheral inner wall of the housing, on the inner front and posterior wall of the housing and on the posterior circular wall of the stationary cam wherein rotational movement of said rotor causes rotation of said shaft.

Any suitable compressed gaseous material may be utilized to power the rotary double engine but not limited to helium, hydrogen, nitrogen or air. Compressed air is the preferred gas. The gas may be compressed to 100 psi to 6000 psi or higher depending on the strength of the tank and the protection around the tank if it explodes. The pressure of the gas when it enters the expansion chamber of the peripheral engine of this invention may be controlled by a pressure regulator. The amount of pressure of the gas entering the expansion chamber will depend on the size of the engine, strength of material of the engine and the number of revolutions desired. The amount of compressed gas that enters the expansion chamber may be regulated by an air valve which controls the length of time that the gas is entering the expansion chamber which allows the compressed gas to expand and exhaust at a lower psi thereby using less compressed gas. The expanded gas may be captured and kept to be re-compressed for further use. The air valve to control the timing and volume of compressed gas that enters the expansion chamber maybe of the mechanical type, magnetic type and electronic controlled type. Magnets on a cam attached to the shaft may be utilized to control the intake of compressed air or combustible fuel by the magnet waves being picked up by a pick-up coil and the waves are magnified and utilized to open the air valve at the right time and for the desired length of time as illustrated in Blount's U.S. Pat. No. 5,734,943 and also utilized in a fuel injection system. A ball valve may be utilized to regulate the amount of compressed air that enters the expansion chamber where in the valve is opened by means of the vanes pushing against the ball in the valve or by a cam which is attached to the shaft which pushes against the valve to open it. The combustible fuel that enters the compression or expansion chamber of the central engine or peripheral engine may be obtained by means of suction, compressed combustible gas or by using an injection system.

### DESCRIPTION OF THE DRAWINGS

Other objects of the invention will become apparent upon reading the annexed detail description in connection with the drawings in which:

FIG. 1 is a plan exterior side view of a rotary double engine powered by compressed gas in the peripheral engine and combustion gas in the central engine.

FIG. 2 is a plan cross sectional view of FIG. 1, a rotary double engine powered by compressed gas in the peripheral engine and combustion gas in the central engine, having 6 vanes to divide the compression and expansion chamber of the peripheral and central engines.

FIG. 3 is a plan sectional view of FIG. 1, a rotary double engine powered by compressed gas in the peripheral engine and combustion gas in the central engine.

FIG. 4 is a plan cross sectional view of a rotary double engine powered by compressed gas in the peripheral engine and by combustion gas in the central engine, having 5 curved vanes to divide the compression and expansion chambers of the peripheral and central engines.

FIG. 5 is a plan cross sectional view of a rotary double engine powered by compressed gas in the peripheral engine and by combustion gas in the central engine, having 4 vanes to divide the expansion and compression chambers of the peripheral and central engines.

FIG. 6 is a plan cross sectional view of a rotary double engine powered by compressed gas in the peripheral engine and by combustion gas in the central engine, having 8 vanes to divide the expansion and compression chambers of the peripheral and central engines.

FIG. 7 is a plan side view of the exterior of a rotary double engine powered by compressed gas, illustrating the compressed gas line going into the regulator then into a gas valve which is opened and closed by a rotor and/or a vane.

FIG. 8 is a plan cross sectional view of the rotary double engine of FIG. 7, both the peripheral and central engine is powered by compressed gas and having 12 vanes to divide the expansion and compression chambers of the peripheral and central engines.

FIG. 9 is a plan exterior side view of a rotary double engine in which both the peripheral and central engines are powdered by combustion gases.

FIG. 10 is a cross sectional view of FIG. 9 having 6 vanes to divide the expansion and compression chambers of the peripheral and central engines.

FIG. 11 is a plan section view of FIG. 9 showing a magnetic wave pickup system to control the compressed air intake and the fuel intake.

FIG. 12 is a cross section view of FIG. 9 having 12 vanes to divide the expansion and compression chamber of the peripheral and central engines.

FIG. 13 is a plan sectional view of a vane with seals.

FIG. 14 is a plan section of the vane.

FIG. 15 is a plan anterior view of the rotor.

FIG. 16 is a plan posterior view of the rotor.

FIG. 17 is a plan sectional view of a mechanical air valve and the cam for a 6 vane double engine.

FIG. 18 is a plan cross section view of a mechanical air valve and the cam for a double engine with 6 vanes.

FIG. 19 is a plan section view of a mechanical air valve and the cam for a 4 vane double engine.

FIG. 20 is a plan cross section view of a mechanical air valve and cam for a 4 vane double engine.

FIG. 21 is a plan exterior side view of a double engine showing the mechanical valve for controlling the intake of compressed air into the double engine.

### DESCRIPTION OF PREFERRED EMBODIMENT

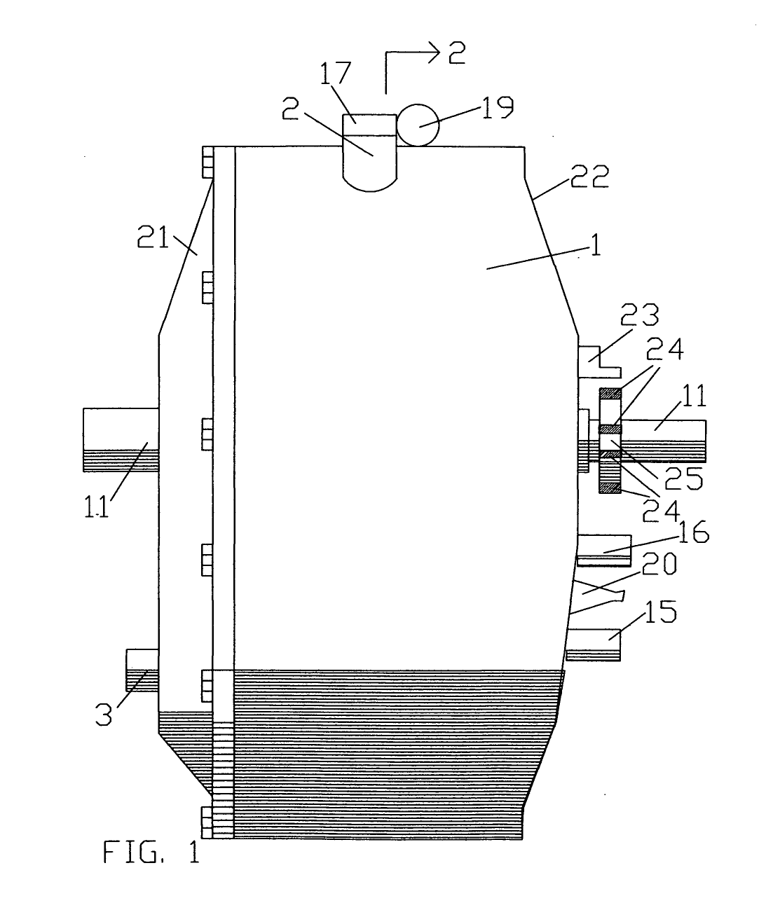

Referring to the drawings and in particular to FIG. 1, the rotary double engine of the present invention includes a plan view of the outside of the housing 1 with and inner circular wall which has an intake (2) for compressed gas which is controlled by a valve 17 and a regulator 19 and the anterior wall 21 and posterior wall 22 is attached to the housing 1, there is a shaft 11 extending out the anterior wall 21 and the posterior wall 22, there is a exhaust port 3 extending out of the anterior wall 21, there is a cam 25 containing magnets 24 which is attached to the shaft 11 and above the magnets 24 is a magnet wave pickup 23, below the shaft 11 there is a fuel inlet 16, exhaust port 15 for exhaust fumes and an ignition plug 20.

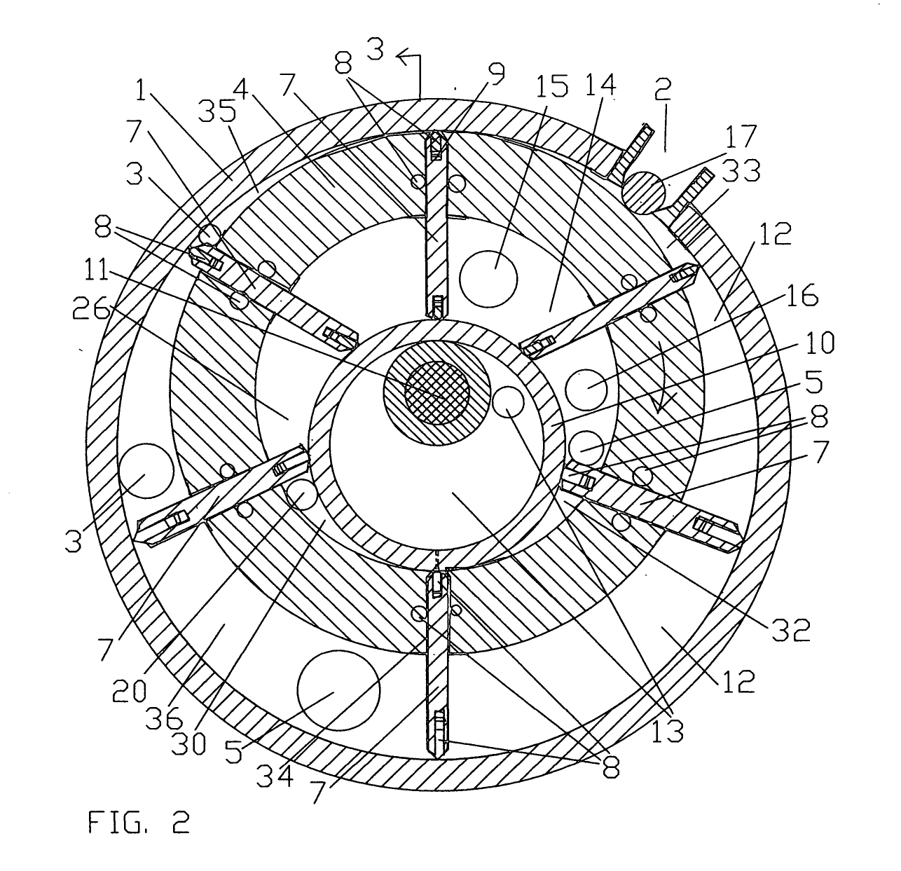

FIG. 2 is a cross section of FIG. 1 which is the rotary double engine of this invention illustrating the housing 1 with the intake 2 and the ball valve 17, rotor 4, cam 10, shaft 11, central expansion chamber 26, vanes 7 with seals 8 and spring 9 which passes through the slots 34 in the rotor 4, exhaust ports 3 in the peripheral compression chambers 36, gas passage 5 from the peripheral compression chamber 36 to the central expansion chamber 24. It also illustrates the peripheral expansion chambers 12, the peripheral compression chambers 36, central exhaust ports 15, central intake port 16, central compression chamber 14, smallest central chamber 32, central ignition port 20 and central oil chamber 13. When the eccentric rotor 4 rotates 180 degrees the expansion chambers are enlarged and the compression chambers are made smaller.

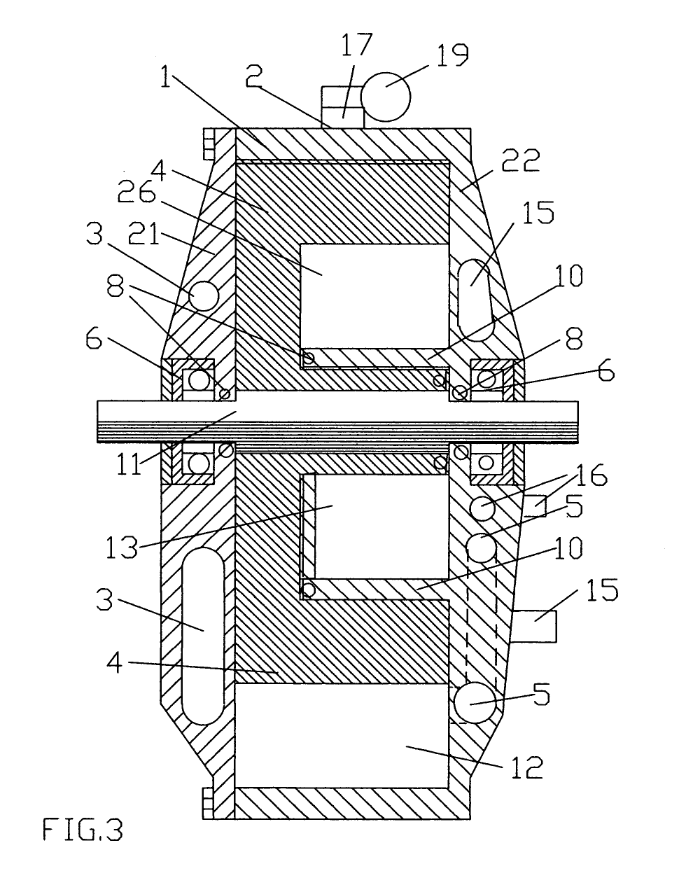

FIG. 3. is a sectional view of FIG. 1 showing the housing 1 being attached to the posterior wall 21 and anterior wall 22, has an compressed gas intake 2 connected to a gas valve 17 and a regulator 19, the housing 1 cavity contains rotatable eccentric rotor 4, stationary cam 10 attached to the posterior wall 22, peripheral expansion chamber 12, the rotor 4 contains the central expansion chamber 26, the stationary cam 10 is connected to the center of the posterior wall and the center chamber of the cam 10 contains an oil chamber 13, a rotatable shaft 11 passes through the center of the rotor 4 and is attached to the rotor 4 and it extends out through the anterior wall 22 and the posterior wall 21 and bearings 6. The anterior wall 22 contains the peripheral motors exhaust ports 3, the posterior wall 21 contains the central engines exhaust ports 15, the intake port 5 for passage of partially decompressed gas for the peripheral compression chamber 12, central fuel intake port 16 and central exhaust port 15.

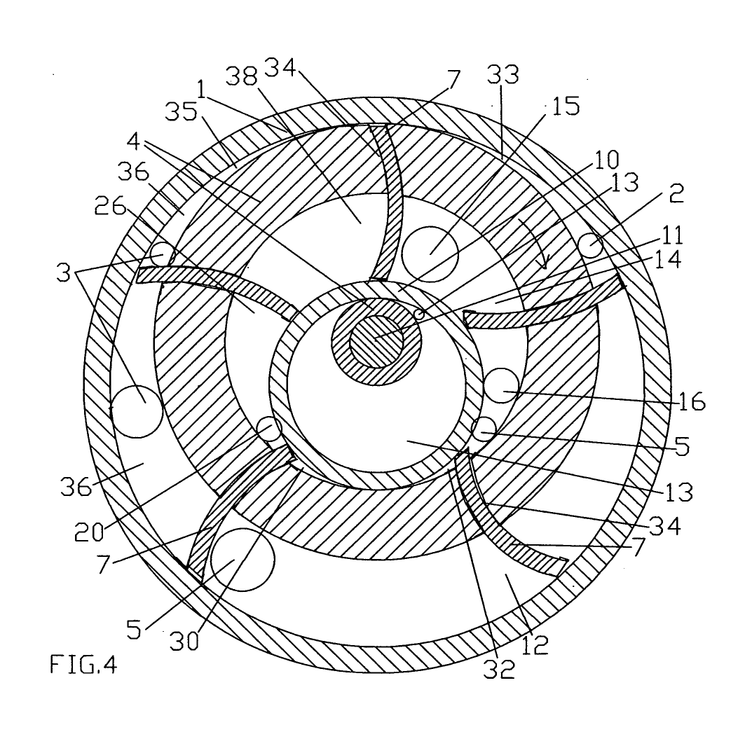

FIG. 4 is a cross section of rotary double engine like FIG. 1 of this invention except that it has 5 movable curved vanes 7 which divided the peripheral expansion chamber 12 and the central compression chambers 14 on one side and on the other side the vanes 7 divide the central expansion 38 and peripheral compression chamber 14 into separate chambers by utilizing close tolerance between the vanes 7, side walls 21 and 22, housing 1 and cam 10. The drawing shows the housing 1, contains a rotatable rotor 4 eccentrically located in the housing 1, a stationary central located cam 10 attached to the posterior wall 21 and which contains an oil chamber 13, a shaft 11 which is attached to the rotor 4, a peripheral expansion chamber 12 with a intake port 2 in the anterior side wall 22 opens into the smallest expansion chamber 33, a peripheral compression chamber 36 containing a passage 5 to the central compression chamber 14 and an exhaust ports 3. The rotor 4 contains a central chamber which is divided into separate chamber s by the vanes 7 into compression chamber 14 and expansion chambers 38 to form the central engine. The rotor 4 has central expansion chambers 38 and compression chambers 14, the central expansion chamber 26 has a ignition port 20 in the posterior wall 21 and gas exhaust port 3 in the anterior wall and the central compression chambers 14 has a fuel intake port 16 in the posterior wall 21 and an partially decompressed gas port 5 from the peripheral exhaust chamber 36 with a passage way to the central compression chamber 14.

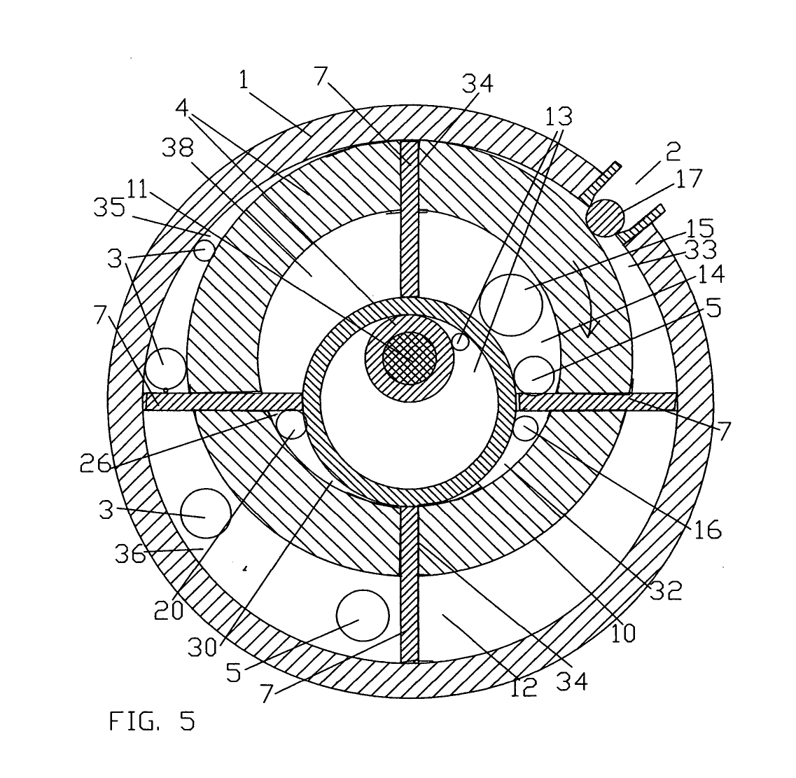

FIG. 5 is a cross section of the double engine like FIG. 1 of this invention except that the engine has 4 vanes. The housing 1 has an intake port 2 with a ball valve 17 and the housing 1 cavity contains an eccentric located rotatable rotor 4 which contains slots 34 for movable vanes 7 to pass through and divided the chambers into separate chambers, a central expansion chamber 26 which has an ignition port 20 in the posterior wall 21, a fuel intake port 16 in the posterior wall 21, and air intake port 5 which is connected to a passage way to intake port 5 in the peripheral compression chamber 36, a central compression chamber 32, a stationary cam 10 attached to the posterior wall and located in the center of the housing and has an oil chamber in the center of the cam 10, a shaft 11 passes through the center of the rotor 4 and is attached to the rotor 4. The peripheral engine is in the peripheral area of the housing 1 cavity and has a expansion chamber 12 and an exhaust 3 in the peripheral compression chambers 36. The peripheral expansion chamber 12 expands for 180 degrees and the exhaust or compression chamber 36 contracts for 180 degrees and has a partially decompressed gas port 5 which is connected to the central partially decompressed gas port 5 in the central compression chamber 14, and exhaust ports 15 through the posterior wall 21.

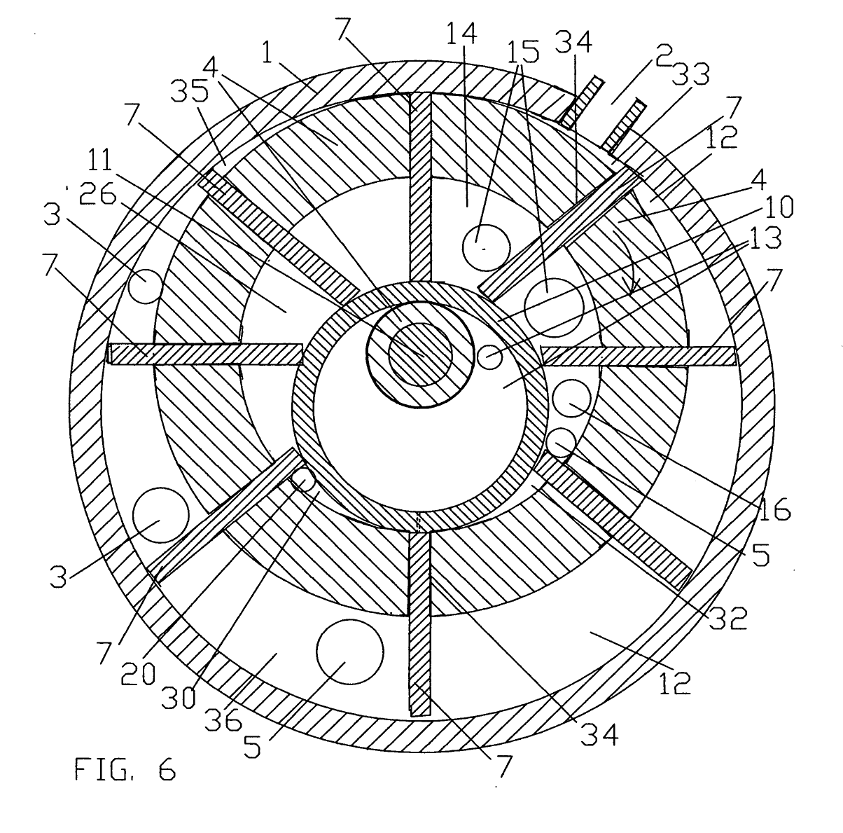

FIG. 6 is a plan cross section of the rotary double engine like FIG. 1 of this invention except that the double engine has 8 vanes 7 which divide the peripheral chambers into 4 expansion chambers and 4 exhaust or compression chambers 36 and 4 central expansion chambers 26 and 4 compression chambers 12.

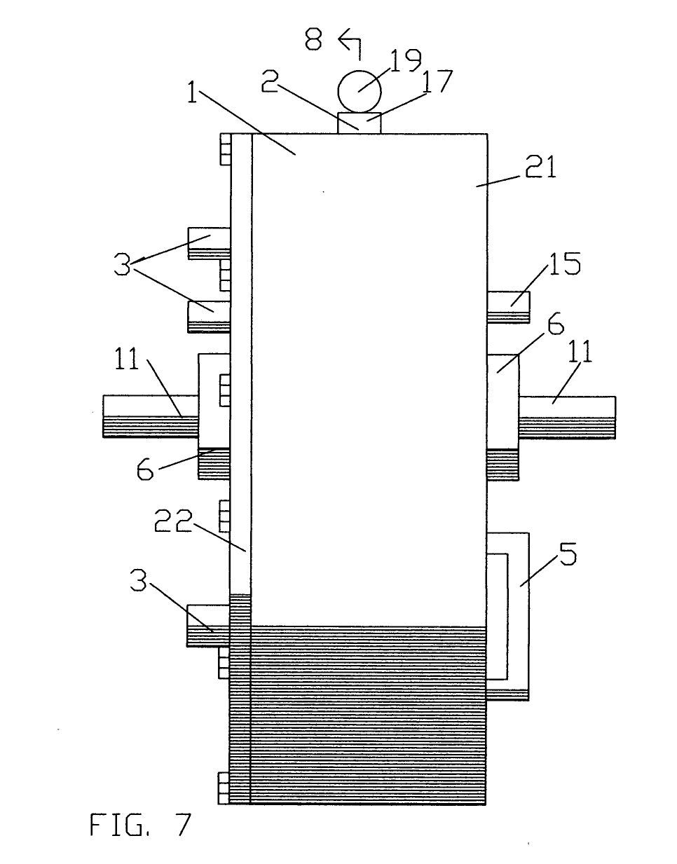

FIG. 7 is a plan exterior side view of the rotary double engine like FIG. 1 except that it is powered by compressed gas and does not have an ignition system. The peripheral engine is powered by compressed gas and the central engine is powered by the partially decompressed gas from the compression chamber 36 of peripheral engine. The compressed gas pressure is controlled by the pressure gage 19 and the timing and amount of gas is controlled by the valve 17 and the gas passes thru the intake port 2. The gas from the peripheral engine is exhausted thru the exhaust passage 5 and the exhaust ports 3 in the anterior wall 22. The decompressed gas passes out the central engine from the central compression chambers 14 thru the gas port 15 and the partially decompressed gas from the peripheral engine passes thru the passage way 5 to the central engine's expansion ports 26. The engine's rotatable shaft protrudes out through the anterior wall 22 and the posterior wall 21 and thru bearings. The anterior wall 22 is bolted to the side of the housing 1.

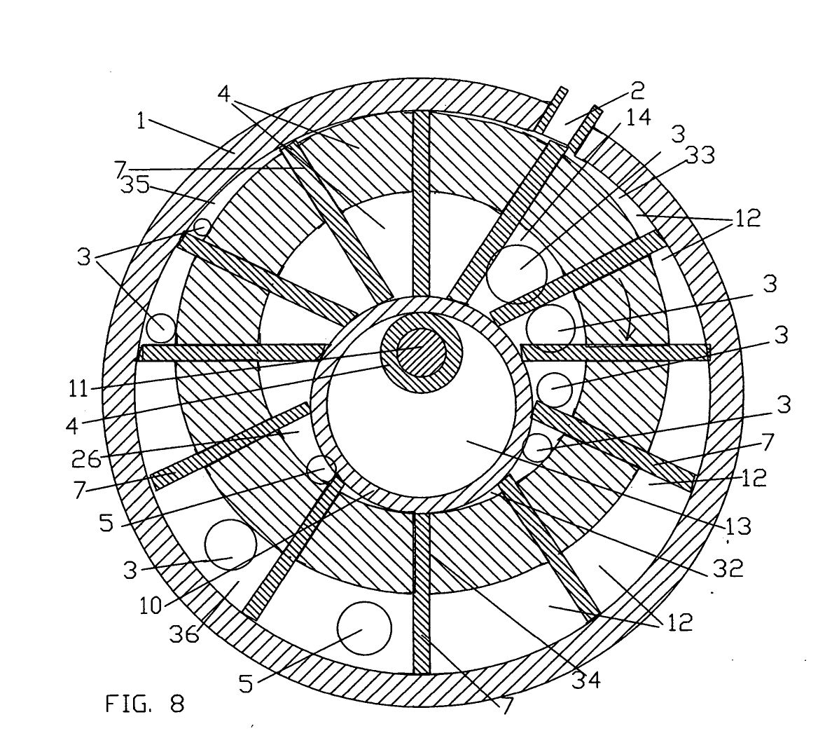

FIG. 8 is a plan cross section of FIG. 7 in which the housing 1 cavity contains a rotatable, eccentric located, rotor 4 which has 8 movable vanes 7 of equal size passing thru the slots 34 and bears up against the inner peripheral wall of the housing 1, posterior wall 21, anterior wall 22 and the stationary cam 10. The central engine is located in the central area of the posterior side of the rotor 4. The peripheral largest compressing chamber 36 contains a passage way 5 to the smallest expanding central chamber 26 and the other peripheral expansion chamber contain exhaust ports 3. The central compression chambers 14 has decompressed gas exhaust ports 15. In the center of the rotor 4 is the rotatable shaft 11 which is attached to the rotor 4 and rotates with the rotor 4.

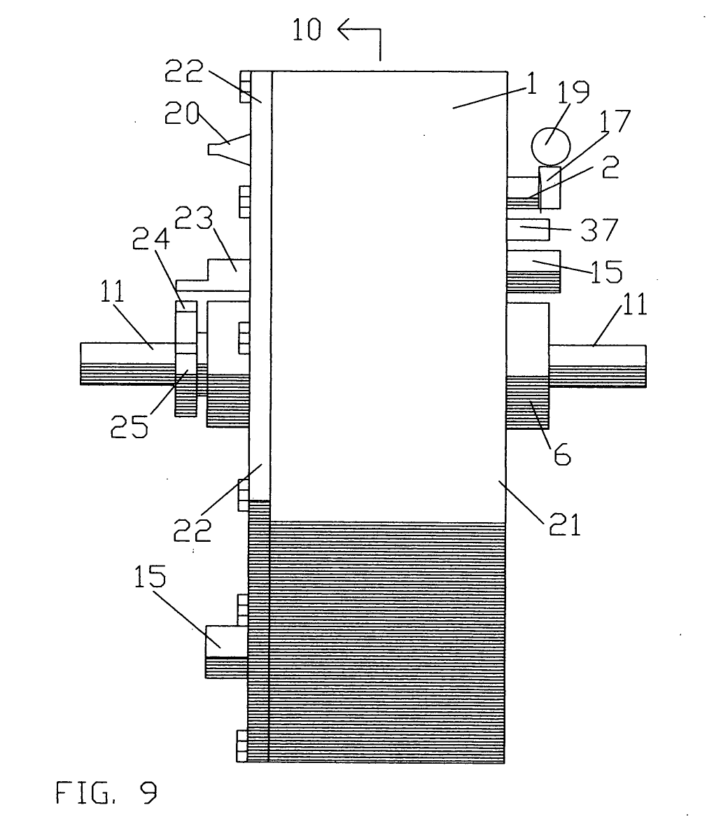

FIG. 9 is a plan exterior side view of a rotary double engine similar to FIG. 1 except that it is a combustion engine in which the compressed air and the combustible fuel is injected into the smallest expansion chamber of the peripheral engine and ignited by the ignition system 20. The compressed air from an air tank goes thru a regulator 19 to obtain the desired air pressure and the timing and the amount of air that passes into the peripheral chamber is regulated by an air valve 17 and passes through the compressed air port 2. The combustible fuel enters the peripheral expansion chamber by means of a fuel injection system 37 or by a combustible gas valve control system. The posterior wall 21 has compression air intake 2, fuel injection 37 and central engine exhaust ports 15. An eccentric located shaft 11 passes thru the anterior wall 22 and posterior wall 21 and thru bearings 6. The anterior wall 22 is attached to the housing 1 and has ignition port 20, exhaust port 15 and attached to the anterior wall 22 is a magnetic pickup which picks up the magnetic waves from the magnets 24 on the timing pulley 25 which is attached to the shaft 11. The posterior wall 21 may be molded with the housing or bolted to the housing.

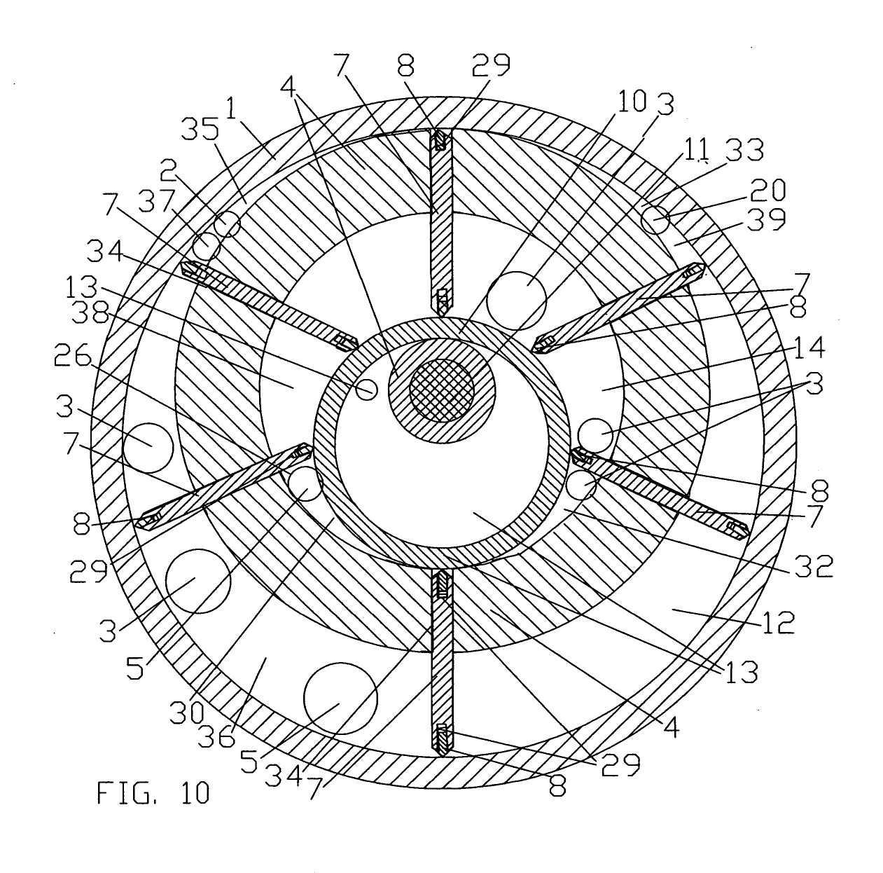

FIG. 10 is a plan cross section of the FIG. 9 which is similar to FIG. 2 except that it is a combustion engine and the ignition system 20 is located in the smallest peripheral expansion chamber of the peripheral engine and the compressed air intake 2 and the fuel intake port 37 is located in the smallest peripheral engine's compression chamber 35 wherein the fuel/air mixture is compressed then rotated to the peripheral combustion chamber 33. The expanding combustion gas rotates the expansion chamber to the largest peripheral compression chamber and the partially decompressed combustion gas goes thru the exhaust passage 5 to the minimum center engine expansion chamber 30. The rotatable rotor 4 is eccentric located in the housing 1 cavity and attached to a rotatable shaft 11 which is located in the center of the rotor 4. The peripheral engine chambers are located between the interior wall of the circular housing 1, peripheral wall of rotor 4, anterior inner side wall 22 and posterior inner side wall 21. The central engine is located in the center of the rotor 4 between the inner side wall of the rotor 4, stationary cam, anterior wall of the rotor 4 and posterior wall 21. There are 6 equal size vane with seals 8 around the edges of the vanes 7. The vanes 7 are movable and pass thru the slots 34 in the rotor 4 and rotates with the rotor 4 while keeping the vanes 7 side walls against the inner peripheral wall of the housing 1, stationary cam 10, anterior wall 22 and posterior wall 21. The cam is attached to the posterior wall 21 centrally. The expanded combusted gas is exhausted through the exhaust port 3.

FIG. 11 is a plan sectional view of FIG. 9 which is a combustion double engine illustrating the location of the vanes 7 by dotted lines where they fit up against the housing 1 posterior wall 21, anterior wall 22 and cam 10. The vanes are movable and slide through slots 34 in the rotor 2.

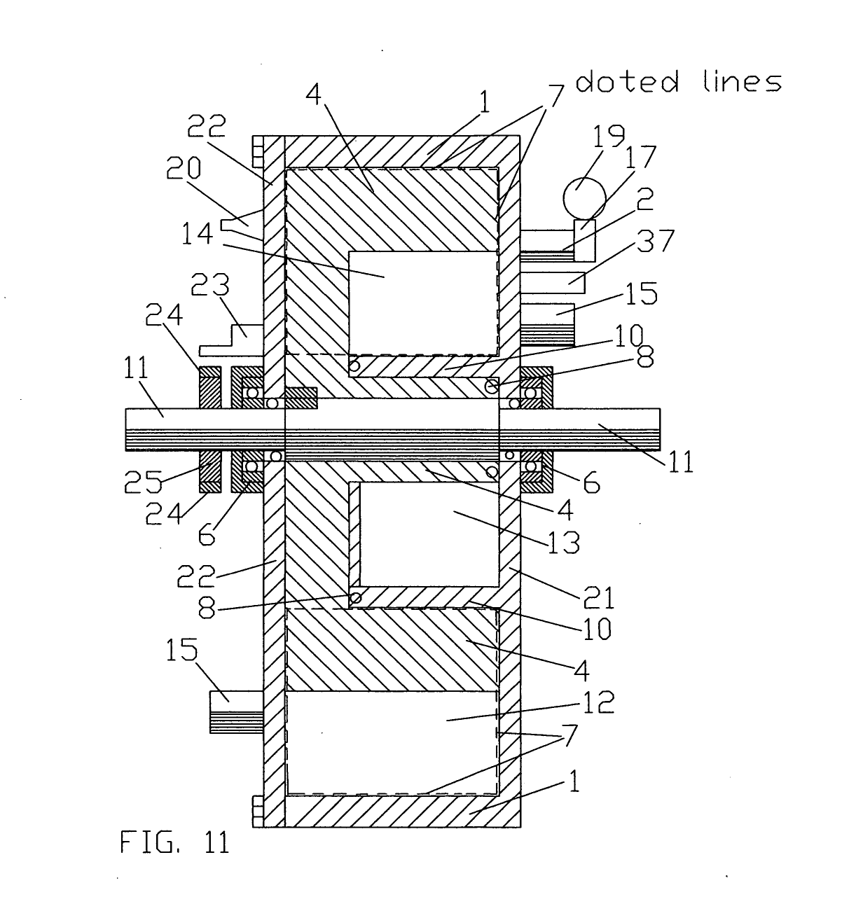

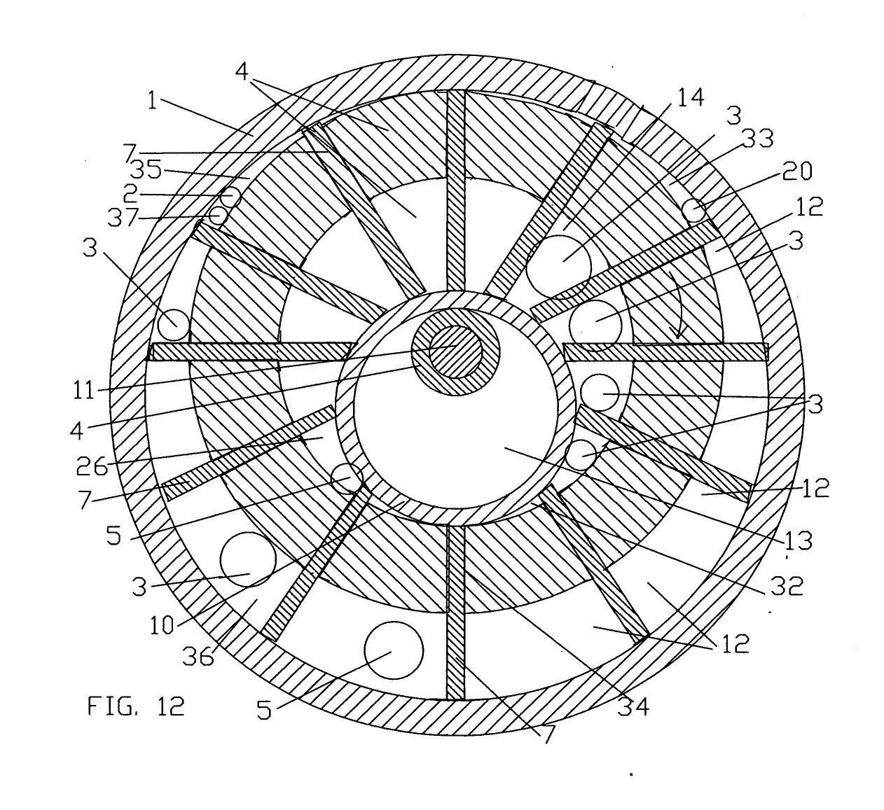

FIG. 12 is a plan cross section of FIG. 9 which is a combustion double engine except that it has 12 vanes which utilizes close tolerance of the space between the vanes 7, housing 1, side walls 21 and 22 and cam 10.

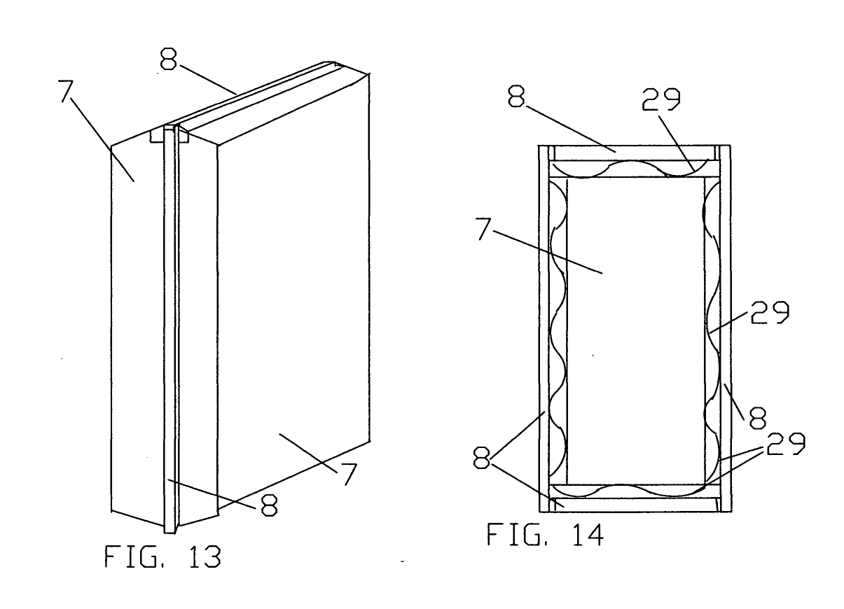

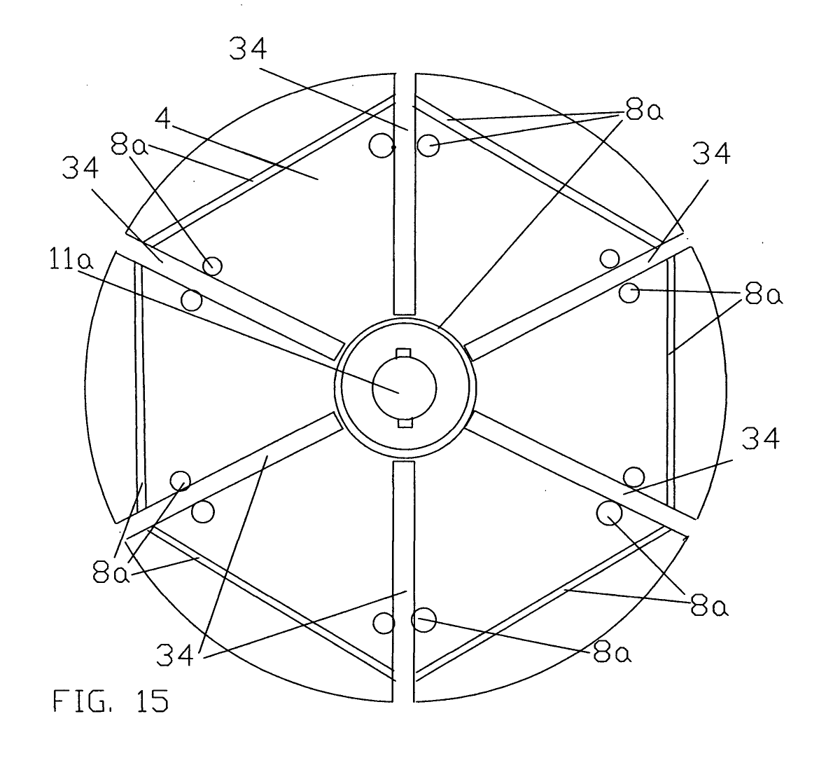

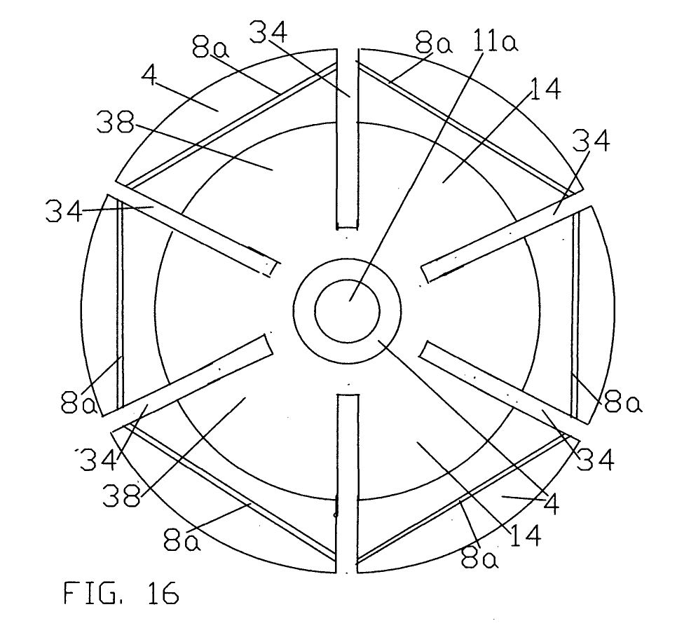

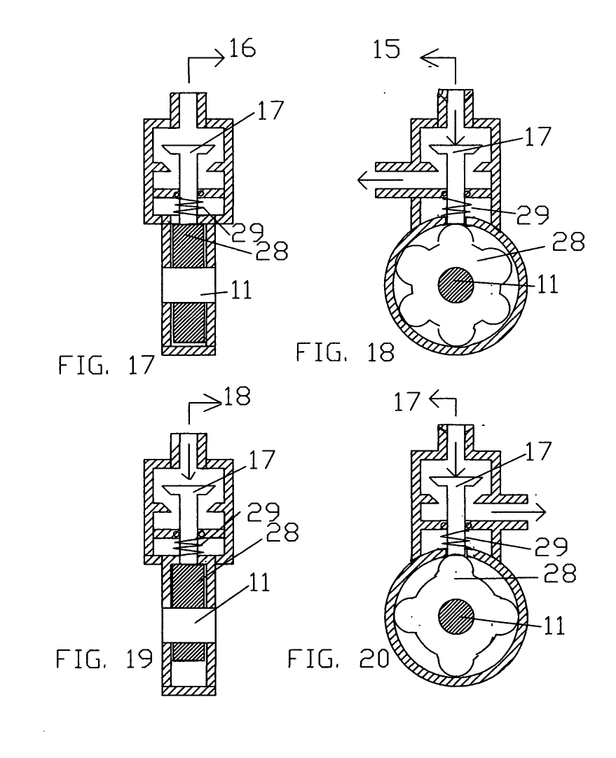

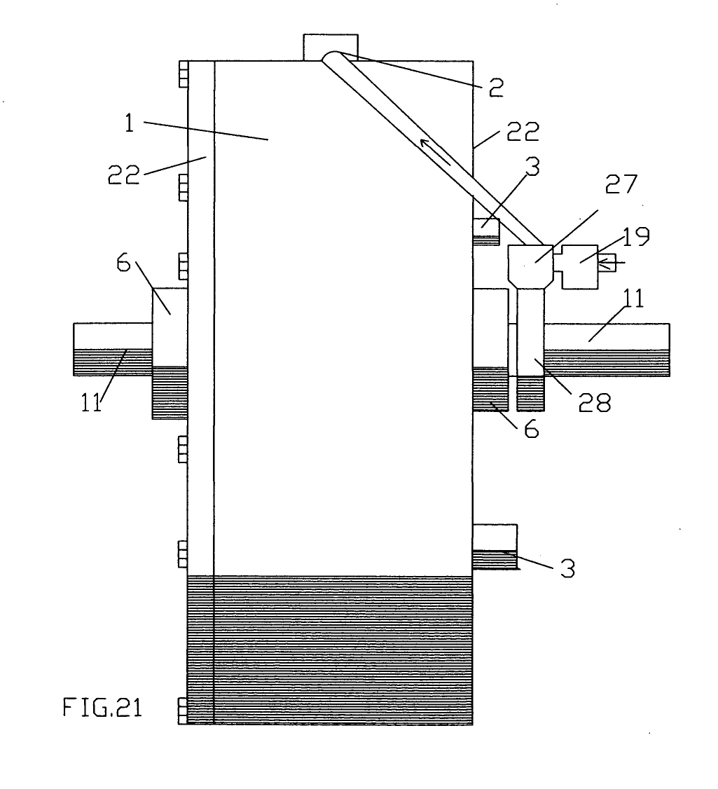

FIG. 13 is a plan side view of the vane 7 with seals 8. FIG. 14 is a plan cross section of the vane 7 showing the seals groves 8a and spring 29 which separates the chambers from each other. FIG. 15 is a plan anterior view of the rotor 4 showing the seal groves 8a, the rotor slots 34 and the shaft passage 11a thru the rotor 4. FIG. 16 is a plan posterior view of the rotor 4 showing the rotor slots 34, the seal groves 8a, the shaft's passage 11a and the central engine's expansion chamber 38. FIGS. 17, 18, 19 and 20 illustrates mechanical valves which are opened and closed by nobs on the cam 28. There is a nob on the cam for each vane 7 and the cam 28 is attached to the shaft 11 and rotates with it.

FIG. 21 is a plan exterior side view of the rotary double engine which is powered by compressed gas. The amount and length of time the gas enters the compressed gas port 2 is regulated by the mechanical valve 30 which is controlled by the cam 28 which is attached to the shaft 11. The gas pressure is regulated by the gas regulator 19.

### Operation

The rotary double engine of FIGS. 1, 2, 3,4, 5, 6 and 8 are powered by compressed air in the peripheral engine located in the peripheral housing 1 cavity and by partially decompressed air and ignited combustible fuel in the central engine located in the rotor 4 and these double engines operates the same except they may have a different number of vanes 7.

These rotary double engine operates by compressed air passing through the intake 2 into the least expanded peripheral expansion chamber 33 and the rotor 4, vanes 7 and shaft 11 are rotated clockwise by the force of the pressurized air on the vane and outer surface of the eccentric located rotor 4 and the expansion chamber 12 expands as the rotor 4 rotates 180 degrees clockwise in the housing 1 cavity and the movement of the movable vanes 7 through the rotor's slot 34 and at the same time decreasing the volume in the central engine's compression chamber 14 and peripheral compression chambers 36 and increases the volume of the central expansion chamber 26 in the rotor's central chamber. After the rotor 4 rotates 180 degrees the peripheral expansion chamber 12 no longer expands and starts to compress then part of the partially decompressed air pass through the exhaust passage way 5 which has a passage way to the central engine's compression chamber 14 and the remaining partially decompressed air is exhausted through the exhaust ports 3 in the peripheral compression chambers 36. The partially decompressed air that passes into the rotor's central compression chamber 14 is mixed with a combustible fuel from the fuel intake port 16 on the posterior wall and is compressed by the clockwise rotation of the eccentric rotated rotor 4 and vanes 7 and stationary cam 10 to the smallest central compression chamber 32 then after the compression chamber has a minimum volume of compressed air/fuel mixture and then the air/fuel mixture passes into the smallest central expansion chamber 30. The air/fuel mixture in the center engine is then ignited by a spark plug or glow plug 20 and the combustion force pushes against the vane 7, inner wall of the eccentric rotor 4 and outer wall of the cam 10 and rotates the rotor 4, vanes 7 and shaft 11 clockwise and the central expansion chamber 26 expands for 180 degrees of rotation. After the rotor 4 rotates 180 degrees the hot exhaust fumes are pushed thru the exhaust port 15 and circulated in the posterior wall 21 and housing 1 wall to heat the compressed air then exhausted through an exhaust port 15. The peripheral engine starts the rotation of the vanes 7, rotor 4 and shaft 11 first by the force of the compressed gas then the central engine compresses the fuel air mixture and as it rotor 4 rotates the fuel/air mixture is ignited by the ignition system 20 then both engines are running at the same time.

The compressed gas is stored in a tank and the pressure of the gas may be regulated by a regulator and is connected to a gas valve which controls the timing and amount of compressed gas that flows into the inlet port 2 of the peripheral engine. The gas valve 17 may be a ball valve in the housing 1 above the peripheral engine's expansion chamber 33 with the least volume and opened and closed by the vanes 7 and/rotor 4. The gas valve may also be located above a cam 25 on the shaft which open the valve for a desired amount of time then closes the gas valve and is connected to the gas intake 2. The ignition system 20 and fuel system 37 may be controlled by a cam 25 on the shaft 11 with magnet 24 on the cam 25 and the magnet waves are picked up by a magnet wave pickup 24 and electronically control the magnetically control fuel injection system 37 and ignition system. A magnetic air valve 17 may be used which controlled by the magnets 25 on the cam 25 on the shaft 11 may be utilized to control the timing and volume of the compressed gas going into the intake port 2. A glow plug may be used as the ignition system. Compressed gas force on the rotor's 4 outer wall and vanes 7 causes the rotor 4 to move eccentrically and is attached to the shaft 11 therefore driving the motor shaft which rolls thru 2 bearings 6. The rotor 4 is cushioned by a thin air film. Varying the performance of the motor can be achieved manually by the varying the gas pressure and the time and duration which the gas is allowed to enter the smallest peripheral chamber 33 and the amount of fuel allowed to enter the central compression chamber 14. A longer inlet period allows more gas to flow into the smallest peripheral chamber 33 and therefore results in more torque; while a shorter inlet period will limit the gas supply allowing the gas in the peripheral expansion chamber to perform expansion work at a much higher efficiency. Motor speed and torque are controlling by the amount of gas pressure and fuel that needs to goes into the motor.

The hollow cam 10 in the center of the housing 1 contain oil with small passage ways to parts that need to be oiled. Close tolerance of the parts and/or seals are used to separate the expansion chambers 12 and 26 from each other, the compression chambers 26 and 14 from each other and the two engines from each other. The seals are made of a strong, hard metal that wears well.

The rotary double engine of FIGS. 7, 8 and 9 is powered by compressed gas and the engine is basically the same as FIG. 1 except that it does not have an ignition system and no combustion gasses. The compressed gas that is utilized to run this rotary double engine is entered through the intake 2 and the amount of gas and the timing that it enters the least expanded peripheral engine's expansion chamber 33 is controlled by a gas valve which either controlled by a round ball valve 17 which is opened or closed with a vane 7 and/or rotor or a mechanical valve controlled by a cam 28 attached to the shaft 11 or by a magnetic valve 17 controlled by magnets 25 on a cam 25 attached to the shaft 11. The compressed gas pushes on the vanes and outer wall of the eccentric located rotor and rotates the rotor 4, vanes 7 and shaft 11 clock wise thereby expanding the peripheral engine's expansion chamber 12 and rotates 180 degrees. After rotor 4 rotating 180 degrees the peripheral expansion chamber 36 began to compress the chamber and passes a exhaust port 5 which has a passage way to the central engine's smallest expansion chamber 26 and part of the partially decompressed gas passes to the central's engine's expansion chamber 26 and the rest is exhausted out the exhaust port 3 in the peripheral compression chamber. The partially decompressed gas in the smallest expansion chamber 26 of the central engine applies a force on the vane 7 and external wall of the eccentric rotor 4 and rotates the rotor 4, vanes 7 and shaft 11 clockwise for 180 degrees to the central compression chamber 14 where it is exhausted through the exhaust ports 15. The clockwise rotation of the peripheral engine is started by the compressed gas entering into the peripheral smallest expansion chamber 33 and the gas pressure pushed the engines 180 degrees to the peripheral compression chamber 36 wherein the partially compressed gas passes thru the exhaust passage 5 into the central smallest expansion chamber 30 and the gas pressure on the vanes 7 and outer wall of the rotor 4 starts to put pressure the central engine's vanes 7 and rotor 4 and both the engines are rotating at the same time by compressed air force on the vanes 7 and rotor 4.

The rotary double engine of FIGS. 9,10 and 11 is basically the same as FIG. 1 except that air intake 2 and the fuel intake port 37 is located in the smallest compression chamber 35 of the peripheral engine and the spark plug or glow plug port 20 is located in the smallest peripheral expansion chamber 26. The shaft is rotated by any suitable means thereby opening the compressed air valve and the fuel injection system into the smallest peripheral compression chamber 35 thereby mixing the air and fuel and compressing the air/fuel mixture in the peripheral engine's compression chamber 35 and is rotated clockwise to the smallest peripheral expansion chamber 33 then ignited by the ignition system 20. The combustion force pushes on the vane 7 and exterior wall of the rotor 4 thereby rotating the eccentric rotor 4, shaft 11 and movable vane 7, which slides through the slots 34 in the rotor 4 and the peripheral expansion chamber expands and the rotor 4, vanes and shaft 11 rotates for 180 degrees. The eccentric rotation of the rotor 4 in the housing cavity and the sliding of the vanes 7 through the rotor's slots increase the size of the expansion chambers and reduces the size of the compression chambers. After the rotor 4 rotates 180 degrees the size of the peripheral chamber begins to be reduced and some of the partially decompressed exhaust fumes are passed through the exhaust port 5 which has a passage way to the smallest central expansion chamber 30 of the central engine and the remaining exhaust fumes are exhausted thru the exhaust ports 3. The partially decompressed exhaust fumes pushes on the vane 7 and inner wall of the rotor 4 and rotates the vane 7, the rotor 4 and shaft 11 for 180 degrees then the expansion chamber 12 is reduce in size and the exhaust fumes are exhausted through the exhaust port 15 at the same time that the peripheral engine is working. This cycle of compression of the air/fuel mixture, ignition of the air/fuel mixture and expansion of the combustion gases then exhausting the fumes takes place in every chamber between two vanes 7. The peripheral and central engines operates at the same time.

In this combustion rotary double combustion engine the central engine may be used for sucking in the air/fuel mixture instead using exhaust fumes to rotate the central engine. The air and fuel mixture may be sucked into the smallest central expansion chamber 26 using a carburetor. The air/fuel mixture is sucked through and intake port 2 into the central expansion chamber 38 which expands as the rotor 7 rotates 180 degrees and then compressed as the rotor 4 rotates in the central compression chamber. The compressed air/fuel mixture in central compression chamber 14 is pushed through a passage to the smallest peripheral compression chamber 35 where it is compressed then rotated into the smallest peripheral expansion chamber 33 and ignited.

What is claims is:

1. A rotary double engine comprising, a housing formed with a peripheral wall which contains a cylindrical inner wall and is attached to side walls at 90 degrees, a cylindrical rotor eccentric and rotationally mounted in said housing and having a circular peripheral wall, side walls at 90 degrees to said peripheral rotor's wall, with one side wall of said rotor having a centrally located chamber, with one side wall of said rotor having means to be attached to an engine's shaft which protrude through the center of the said rotor and eccentrically through said side walls and the other said rotor side wall having a circular central chamber, and one or more expandable or compressible chambers in the peripheral area of said housing extending from the said rotor's peripheral wall to the housing's inner wall and one or more expandable or compressible chambers in the central said rotor's chamber extending from the said rotor's inner wall to the cam's outer wall, said rotor having slots containing movable vanes with means to seal said expansion or compression chamber from the other chambers of the peripheral and central engine and the means to seal said expansion or compression chambers of the peripheral chambers from the said rotor's central chambers and having means of forming variable volume in said peripheral and central chambers enabling the cycle of suction, expansion, compression and exhaustion, the said rotor's peripheral side wall bears on one area of the inner housing wall, said cam is stationary, cylindrical shaped and attached to the center of the posterior wall and extend inward from the posterior wall to the anterior wall of the said rotor and means to rotate the rotor, said housing and/or side walls being provided with means admitting a compressed gas, air, combustible fuel and/or air/fuel mixture, means discharging expanded gas or combustion gas communicating with said expanding or compressing chambers, means for igniting the combustible fuel in the expansion chamber of said rotor, means to guide the said rotor's motions in said housing, said cylinder chambers of varying sizes enabling an expansion of compressed gas and an expansion of combustion gas products to take place and expansion of said chambers and rotation of said rotor and shaft due to the pressure of said compressed gas and/or combustion gas products on said vanes and peripheral wall of said rotor.

2. The rotary double engine according to claim 1, wherein the peripheral wall and/or side walls of said housing is provided with exhaust ports extending there through into a channel in the posterior wall and peripheral wall of housing to heat the compressed gas and is provided with intake port extending there through, said intake ports being adapted to be opened or closed by said rotor or vanes or mechanical valve during rotation and constituting said means for admission of compressed gas and/or air/fuel mixture or combustible fuel is provided with means for discharging the expanded gas through a passage way in the posterior wall, peripheral housing wall and/or anterior wall.

3. The rotary double engine according to claim 1, wherein the peripheral engine expansion and compression chambers are sealed from the central engine expansion and compression chambers by means of seals on the rotor and vanes.

4. The rotary double engine according to claim 1, wherein the compressed gas, combustible fuel, and/or fuel/air mixture entering thru the said intake ports which are controlled by a mechanical gas valve timed by a timing member mounted onto the output shaft to rotate with said shaft, and a gas pressure regulator.

5. The rotary double engine according to claim 1, wherein the hot combustion gas from the compression chamber of the rotor is exhausted thru a passage in the posterior wall and peripheral housing wall to heat the expanding gas in the peripheral expansion chambers then exhausted through a exhaustion port.

6. The rotary double engine according to claim 1, wherein the said compressed gas is compressed air and the combustible fuel in the rotor's expansion chamber is a fuel selected from the group consisting of gasoline, diesel, propane, natural gas, hydrogen and mixtures thereof.

7. A rotary double engine consisting of a peripheral engine and a central engine both having a cycle of intake, compression, expansion and exhaustion, said double engine comprising:
a) a housing formed with a peripheral wall with side walls, said peripheral inner wall being cylindrical, leaving space in said housing for a rotor to rotate eccentrically and being provided with means for admitting compressed gas communicating with peripheral expansion chambers, means for discharging partially decompressed gas from peripheral compression chamber through passage to the smallest rotor's expansion chamber, means for discharging expanded gas communicating with compression chambers:
b) a rotor with a circular peripheral wall with side walls, central chamber in one side wall of said rotor, said chamber which is cylindrical and extended from the inner wall of the rotor to the opposite rotor's inner wall of said central chamber, one side wall of said rotor has means to attach in the center of the rotor to the output shaft which extends through the anterior and posterior walls eccentrically to bear the rotating rotor on one area of the inner peripheral housing wall as the rotor rotates, peripheral rotor wall contain slots for movable vanes to slide back and forth in the side walls of said rotor, said vanes have seals to seal against the housing peripheral wall and side walls and cam to seal off the expansion and compression chambers of both the peripheral and central engine from other expansion and compression chambers, said rotor being eccentrically and rotary mounted in said housing and attached to the engine shaft:
c) vanes which are of equal size, movable, mounted in the rotor slots and bears against the housing's inner peripheral wall, the anterior and posterior side walls and the cam sealing off the expansion and compression chambers from other expansion and compression chambers in both the peripheral and rotor's chambers:
d) cam, cylindrical and with stationary attachment to the center of the posterior wall and extending to the bottom of the central rotor's chamber enabling a suction, expansion, compression and an exhaustion cycle on rotation of the said rotor.
e) Shaft, rotatable, passes through the center of the rotor and attached to the rotor and eccentrically mounted in the housing by means of bearings in the side walls of the housing and passes through the side walls.

8. The rotary double engine of claim 7 wherein the compressed gas is compressed air.

9. The rotary double engine of claim 7 wherein the compressed gas pressure is regulated by a pressure regular.

10. The rotary double engine of claim 7 wherein the compressed gas entering the intake port of the smallest peripheral expansion chamber is controlled by a gas valve selected from the group consisting of a mechanically controlled valve, magnetic controlled valve or an electronically controlled valve and the timing is controlled by a timing member located on the out put shaft or by a ball valve which is opened and closed by the vanes and/or rotor.

11. The rotary double engine of claim 10 wherein the starting means is compressed gas.

12. A rotary double engine consisting of a peripheral engine and a central engine both having a cycle of intake, compression, expansion and exhaustion comprising:
a) a housing formed with a peripheral wall with side walls, said peripheral inner wall being cylindrical, leaving space in said housing for a rotor to rotate eccentrically and being provided with means for admitting compressed air, combustible fuel and/or fuel/air mixture communicating with smallest peripheral compression chamber, means to ignite fuel/air mixture in smallest peripheral expansion chamber, means for discharging combustion gas through passage way communicating into the smallest rotor's expansion chamber and providing means to discharging combustion gases from the largest peripheral compression chamber into the smallest central expansion chamber:
b) a rotor with a circular peripheral wall with side walls, central chamber in one side wall of said rotor, said rotor chamber which is cylindrical and extended from the inner wall of the rotor to the opposite rotor's inner wall of said central chamber, one side wall of said rotor has means to attach in the center of the rotor to the engine shaft which extends through the anterior and posterior walls, peripheral rotor wall contain slots for vanes to slide back and forth and side walls of said rotor has seals to seal against the housing peripheral wall and side walls and cam to seal off the expansion and compression chambers of both the peripheral chambers and rotor's chambers and from other expansion and compression chambers, said rotor being eccentrically and rotary mounted in said housing and attached to the output shaft:
c) vanes which are equal in size, movable, mounted in the rotor slots and bears against the housing's inner peripheral wall, the anterior and posterior side walls and the cam sealing off the suction, expansion and compression chambers from other suction, expansion and compression chambers:
d) cam, cylindrical with stationary attachment to the center of the posterior wall and extending to the bottom of the central rotor's chamber enabling a suction stroke, expansion stroke and compression stroke and an exhaustion stroke;
e) shaft, is rotatable and attached to the rotor and passes through the center of the rotor and mounted eccentrically in bearings in the anterior and posterior side wall and extending out pass the side walls;
f) Timing member, mounted on the output shaft, which controls the timing and amount of the air and fuel through the intake ports.

13. The rotary double engine of claim 12 where in compressed air and combustible fuel is added though intake ports to the smallest peripheral compression chamber.

14. A double engine comprising a cylindrical rotor attached to a eccentric located shaft in a housing cavity surrounded by expansion chambers defined between a peripheral wall of the rotor and wall of the housing cavity and said rotor has cylindrical expansion chambers in the inner walls of the said rotor and said expansion chambers in the housing and rotor are separated by movable vanes mounded in the slots in said rotor and bearing on the cylindrical housing inner wall and outer wall of the stationary cylindrical cam which is attached to center of posterior wall, the eccentrically, rotatable said rotor located in the housing cavity is supported by a shaft attached to the rotor and passing through the center of the said rotor and eccentrically located bearings in the side walls of the housing, said rotor bears at one point on said housing inner wall and said rotor bears on the inner wall of the housing at a circumferential point extending along the length of the cylindrical wall of the rotor, whereby a combination of orbital and rotational movement of said rotor causes rotation of said output shaft.

15. The double engine as defined in claim 14, characterized in that the wall of said peripheral housing chamber is cylindrical and extends between the inner wall of the housing and the exterior peripheral wall of the rotor and the rotor's chamber is cylindrical and extends between the inner wall of the rotor and cylindrical stationary wall of the cam and the chamber of the peripheral chamber and the chamber of the rotor are divided into separate chamber by the same movable vanes which are mounted in slots in the rotor.

16. The double engine as defined in claim 15, characterized in that, the vanes are of the same size and while rotating constantly bears on the inner wall of housing, walls and exterior wall of the cam by moving through the slots in the rotor.

17. The double engine as defined in claim 16, characterized in that said housing has inlet ports to respective expansion peripheral and central chambers and said peripheral chamber and central chamber has outlet or exhaust ports in the compression area of the chambers.

18. The double engine as defined in claim 17, characterized in that, a timing member is mounted onto the output shaft to rotate with said output shaft, said timing member selectively control inlet gas, combustible fuel and/or air/fuel mixture.

19. The double engine as defined in claim 18, characterized in that, the inlet valve is controlled by the rotation of the vanes and/or rotor.
